(19) United States
(12) Patent Application Publication
(10) Pub. No.: US 2018/0037758 A1
(43) Pub. Date: Feb. 8, 2018

(54) Ink Composition For Three-Dimensional Modeling, Ink Set, And Method For Producing Three-Dimensional Model

(71) Applicant: KONICA MINOLTA, INC., Chiyoda-ku (JP)

(72) Inventors: Takayuki ISHIKAWA, Chiyoda-ku (JP); Akiko HARA, Chiyoda-ku (JP)

(21) Appl. No.: 15/555,336

(22) PCT Filed: Feb. 26, 2016
(86) PCT No.: PCT/JP2016/055878

§ 371 Date: Sep. 1, 2017

(30) Foreign Application Priority Data
Mar. 10, 2015 (JP) 2015-047363

(51) Int. Cl. C09D 11/106; B29C 64/209; C09D 11/40; B33Y 70/00; C09D 11/30; C09D 11/102; B29C 64/129; B33Y 10/00

(52) U.S. Cl. CPC C09D 11/106; B29C 64/129; B29C 64/209; B33Y 10/00; B33Y 70/00; C09D 11/30; C09D 11/102; C09D 11/40; B29K 2075/00

(57) ABSTRACT

The purpose of the present invention is to provide: an ink composition for three-dimensional modeling by an inkjet method, which has low viscosity and high ejectability, and which is capable of producing a three-dimensional model having higher tensile strength and higher impact resistance; an ink set which includes this ink composition; and a method for producing a three-dimensional model, which uses this ink composition. This ink composition for three-dimensional modeling contains a photopolymerizable monomer, a polymer and a photopolymerization initiator. The polymer has a weight average molecular weight of from 5,000 to 80,000 (inclusive); the photopolymerizable monomer contains a monomer that is capable of forming a ring structure in the main chain by polymerization; and the difference between the solubility parameter of the photopolymerizable monomer and the solubility parameter of the polymer is from 0.30 (cal/cm³)^{1/2} to 2.0 (cal/cm³)^{1/2} (inclusive).

### TECHNICAL FIELD

The present invention relates to an ink composition for three-dimensional fabrication, an ink set, and a method of fabricating a three-dimensional object.

### BACKGROUND ART

As methods of fabricating three-dimensional objects using photocurable ink compositions for three-dimensional fabrication, widely known are a method in which cured layers, which have been formed by irradiating a liquid surface of a liquid ink composition for three-dimensional fabrication with actinic radiation, are stacked (hereinafter also simply referred to as “SLA method” (SLA stands for stereolithography apparatus)), as well as a method in which cured layers, which have been formed by impacting an ink composition for three-dimensional fabrication on a substrate from nozzles of an inkjet head and irradiating the impacted ink composition with actinic radiation, are stacked (hereinafter also simply referred to as “inkjet method”). Since three-dimensional objects are fabricated relatively easily, they can be used as prototypes for confirming the shapes or properties of final products.

In recent years, there has been a need for fabricating a three-dimensional object with physical properties similar to those of a final product in order to investigate, at a stage of a prototype, whether a final product will function as desired. Three-dimensional objects fabricated using conventional materials, however, often exhibit either one or both of low tensile strength and low impact resistance, and thus sometimes do not meet performance criteria required for prototypes. Therefore, there exists a need for materials that can enhance both these characteristics for fabrication of three-dimensional objects.

Patent Literature (hereinafter abbreviated as PTL) 1 and PTL 2 disclose that an ink composition (for SLA three-dimensional fabrication) containing a cationic polymerizable monomer and a specific polymer has a phase-separated structure after curing, and consequently a three-dimensional object fabricated using the ink composition exhibits both high tensile strength and high impact resistance.

### CITATION LIST

### Patent Literature

### PTL 1

### Japanese Unexamined Patent Application Publication (Translation of PCT Application) No. 2010-520949

### PTL 2

### WO 2004/113056

### SUMMARY OF INVENTION

### Technical Problem

According to the investigation by the present inventors, however, a SLA method sometimes suffers uneven polymerization of monomers contained in an ink composition since actinic radiation, with which a liquid surface is irradiated, is diffused without evenly irradiating the whole ink composition for three-dimensional fabrication with actinic radiation. As a result, three-dimensional objects fabricated by a SLA method even using the ink compositions for three-dimensional fabrication described in PTL 1 and PTL 2 tend to exhibit non-uniform particle size and distribution of domains originated from a polymer, which is phase-separated from monomers, and thus tensile strength and impact resistance of the fabricated three-dimensional objects sometimes cannot be enhanced satisfactorily.

In contrast, in an inkjet method, only fine droplets of an impacted ink composition are irradiated with light, and consequently the effect of light diffusion is reduced and a phase separation structure is formed in every droplet. Accordingly, it is believed that an inkjet method readily achieves uniform particle size and distribution of domains originated from a polymer in a three-dimensional object and thus enables fabrication of a three-dimensional object with satisfactorily enhanced tensile strength and impact resistance.

Incorporation of a polymer into an ink composition leads to a high viscosity of the ink composition and thus low dischargeability from an inkjet head, and consequently a sufficient volume of the ink composition sometimes cannot be discharged at a high speed. In particular, an ink for three-dimensional fabrication used in a SLA method is prepared to have a high viscosity and thus suppress undulation of a liquid surface during irradiation with actinic radiation. Therefore, ink compositions like those used in methods described in PTL 1 and PTL 2 have a high viscosity, and thus are unsuitable for discharge from an inkjet head. Further, according to the investigation by the present inventors, an ink composition for three-dimensional fabrication with a high viscosity is less likely to have a structure of aggregated domains originated from a polymer (which is phase-separated from a monomer) and thus a satisfactorily large particle size of the polymer, and consequently tensile strength and impact resistance are not readily enhanced.

In view of the above-mentioned problems, one object of the present invention is to provide an ink composition for three-dimensional fabrication that has a low viscosity and high dischargeability in an inkjet method, and that enables fabrication of a three-dimensional object with higher tensile strength and impact resistance, an ink set including the ink composition, and a method of fabricating a three-dimensional object using the ink composition.

### Solution to Problem

A first aspect of the present invention relates to the following ink composition for three-dimensional fabrication.

[1] An ink composition for three-dimensional fabrication by an inkjet method, containing: at least one photopolymerizable monomer including a monomer which can form a ring structure in a main chain by polymerization; at least one polymer with a weight-average molecular weight of 5,000 or more and 80,000 or less; and a photopolymerization initiator, in which a difference between a solubility parameter of the at least one photopolymerizable monomer and a solubility parameter of the at least one polymer is 0.30 (cal/cm³)^{1/2} or more and 2.0 (cal/cm³)^{1/2} or less.

[2] The ink composition according to [1], in which the photopolymerizable monomer which can form a ring structure in a main chain by polymerization is a compound represented by formula 1:

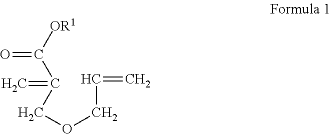

In formula 1, R¹ is a hydrogen atom or a C_{≦20} hydrocarbon group which is substituted or unsubstituted.

[3] The ink composition according to [1] or [2], in which a content of the at least one polymer is 5 mass % or more and 35 mass % or less.

[4] The ink composition according to any one of [1] to [3], in which the at least one polymer has 1 molar equivalent or more of a photopolymerizable functional group, relative to 1 mole of the at least one polymer.

[5] The ink composition according to any one of [1] to [4], in which a weight-average molecular weight of the at least one polymer is 7,000 or more and 30,000 or less.

[6] The ink composition according to any one of [1] to [5], in which the at least one polymer has a structural segment which is compatible with the at least one photopolymerizable monomer and a structural segment which is incompatible with the at least one photopolymerizable monomer. [7] The ink composition according to any one of [1] to [6], in which the at least one polymer includes a urethane polymer.

A second aspect of the present invention relates to the following ink set.

[8] An ink set for three-dimensional fabrication by an inkjet method, including: the ink composition for three-dimensional fabrication according to any one of [1] to [7]; and an ink composition for forming a support region.

A third aspect of the present invention relates to the following method of fabricating a three-dimensional object.

[9] A method of fabricating a three-dimensional object, including: forming a first ink layer region by discharging the ink composition for three-dimensional fabrication according to any one of [1] to [7] from a nozzle of a first inkjet head; forming a model material layer region by irradiating the first ink layer region formed with actinic radiation; and repeating the forming of the first ink layer region and the forming of the model material layer region, thereby stacking a plurality of the model material layer regions to fabricate a three-dimensional object.

[10] The method according to [9], further including: forming a second ink layer region by discharging a second ink composition from a nozzle of a second inkjet head; forming a support material layer region by solidifying the second ink layer region formed; and repeating the forming of the second ink layer region and the forming of the support material layer region, thereby stacking a plurality of the support material layer regions.

### Advantageous Effects of Invention

The present invention provides an ink composition for three-dimensional fabrication that has a low viscosity and high dischargeability in an inkjet method, and that enables fabrication of a three-dimensional object with higher tensile strength and impact resistance, an ink set including the ink composition, and a method of fabricating a three-dimensional object using the ink composition.

### BRIEF DESCRIPTION OF DRAWINGS

FIGS. 1A to 1D, schematically illustrate a method of fabricating a three-dimensional object, where FIG. 1A is a side view illustrating the formation of a first layer, FIG. 1B is a side view illustrating the formation of a second layer, FIG. 1C is a side view illustrating the formation of a third layer of a three-dimensional object, and FIG. 1D is a side view illustrating the formation of a support material-attached three-dimensional object; and

FIG. 2 is a perspective view illustrating a second three-dimensional object fabricated in Examples.

### DESCRIPTION OF EMBODIMENTS

In the following, embodiments of the present invention will be described.

1. Ink Compositions for Three-Dimensional Fabrication

An ink composition for three-dimensional fabrication of the present embodiment is a photocurable ink composition for three-dimensional fabrication by an inkjet method (hereinafter also simply referred to as “model material ink”). The model material ink contains a photopolymerizable monomer, a polymer, and a photopolymerization initiator. As used herein, the phrase “model material” refers to a material that constitutes an intended object. As described hereinafter, a material temporarily used to support the model material during the process of obtaining an intended object is called “support material.”

1-1. Photopolymerizable Monomers

A photopolymerizable monomer is a monomer having a photopolymerizable group, which polymerizes upon irradiation with actinic radiation. The photopolymerizable monomer polymerizes and crosslinks upon irradiation with actinic radiation while undergoing phase separation from a polymer (described hereinafter), and thus forms a model material, which constitutes a three-dimensional object. The photopolymerizable monomer may be one monomer or a plurality of monomers in combination.

Examples of the photopolymerizable groups include a radically polymerizable functional group having an ethylenic double bond, and a cationically polymerizable functional group. Examples of the radically polymerizable functional groups include an ethylene group, a propenyl group, a butenyl group, a vinylphenyl group, a (meth)acryloyl group, an allyl ether group, a vinyl ether group, a maleyl group, a maleimide group, a (meth)acrylamide group, an acetylvinyl group, and a vinylamide group. Examples of the cationically polymerizable functional groups include an epoxy group, an oxetane group, a furyl group, and a vinyl ether group. As used herein, the term “(meth)acryloyl” refers to both or either one of “acryloyl” and “methacryloyl,” the term “(meth)acrylic” refers to both or either one of “acrylic” and “methacrylic,” and the term “(meth)acrylate” refers to both or either one of “acrylate” and “methacrylate.”

From a viewpoint of further enhancing reactivity to irradiation light, the radically polymerizable photopolymerizable group is preferably a (meth)acryloyl group, an allyl ether group, a vinyl ether group, or a maleimide group, more preferably a (meth)acryloyl group or a vinyl ether group, and further preferably a (meth)acryloyl group. Similarly, from a viewpoint of further enhancing reactivity, the cationically polymerizable photopolymerizable group is preferably a vinyl ether group, an epoxy group, or an oxetane group, and more preferably a vinyl ether group or an oxetane group. Among them, from a viewpoint of further enhancing reactivity and broadening options of monomers, the photopolymerizable group is most preferably a (meth)acryloyl group.

1-1-1. Photopolymerizable Monomers that can Form Ring Structures in Main Chains by Polymerization

The photopolymerizable monomers include a photopolymerizable monomer that can form a ring structure in the main chain by polymerization. The monomer forms a nonaromatic ring structure in the main chain during polymerization. The ring structure, which is nonaromatic, disperses and absorbs stress or impact in the tensile direction, which is externally applied on the main chain, by flexible deformation corresponding to external stress. As a result, a model material formed from a model material ink containing such a photopolymerizable monomer is presumably resistant to scission of the main chain, and exhibits higher tensile strength and impact resistance. The photopolymerizable monomer that can form a ring structure in the main chain during polymerization may be used alone or in combination.

From a viewpoint of further enhancing tensile strength and impact resistance, the content of the photopolymerizable monomer that can form a ring structure in the main chain by polymerization is 30 mass % or more and 80 mass % or less, based on the total mass of a model material ink. In view of the above, the content of the photopolymerizable monomer that can form a ring structure in the main chain by polymerization is more preferably 40 mass % or more and 70 mass % or less, further preferably 45 mass % or more and 60 mass % or less, based on the total mass of a model material ink.

Examples of the photopolymerizable monomers that can form ring structures in the main chains by polymerization include a compound having a structure of formula 1.

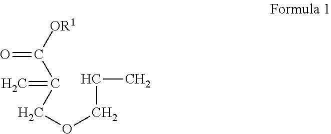

In formula 1, R¹ is a hydrogen atom or a C_{≦30} hydrocarbon group which is optionally substituted. The hydrocarbon group with the carbon number of 30 or less can prevent interference in deformation of a ring structure and lowering in ejection properties due to the side chain. In view of the above, the carbon number of the hydrocarbon group is preferably 20 or less, more preferably 10 or less. The hydrocarbon group may be linear or branched, may contain a double bond, a ring structure, such as an alicyclic or aromatic ring, an ether group, or cyclic ether structure, or may have a combined structure thereof. The hydrogen atom of the hydrocarbon group may be replaced with a halogen atom, or a substituent, such as an amino group or a carboxyl group. Examples of the halogen atoms include fluorine, chlorine, and bromine.

Examples of the compound represented by formula 1 includes α-(allyloxymethyl)acrylic acid, methyl α-(allyloxymethyl)acrylate, ethyl α-(allyloxymethyl)acrylate, n-propyl α-(allyloxymethyl)acrylate, isopropyl α-(allyloxymethyl)acrylate, n-butyl α-(allyloxymethyl)acrylate, sec-butyl α-(allyloxymethyl)acrylate, tert-butyl α-(allyloxymethyl)acrylate, n-amyl α-(allyloxymethyl)acrylate, sec-amyl α-(allyloxymethyl)acrylate, tert-amyl α-(allyloxymethyl)acrylate, neopentyl α-(allyloxymethyl)acrylate, n-hexyl α-(allyloxymethyl)acrylate, sec-hexyl α-(allyloxymethyl)acrylate, n-heptyl α-(allyloxymethyl)acrylate, n-octyl α-(allyloxymethyl)acrylate, sec-octyl α-(allyloxymethyl)acrylate, tert-octyl α-(allyloxymethyl)acrylate, 2-ethylhexyl α-(allyloxymethyl)acrylate, capryl α-(allyloxymethyl)acrylate, nonyl α-(allyloxymethyl)acrylate, decyl α-(allyloxymethyl)acrylate, undecyl α-(allyloxymethyl)acrylate, lauryl α-(allyloxymethyl)acrylate, tridecyl α-(allyloxymethyl)acrylate, myristyl α-(allyloxymethyl)acrylate, pentadecyl α-(allyloxymethyl)acrylate, cetyl α-(allyloxymethyl)acrylate, heptadecyl α-(allyloxymethyl)acrylate, stearyl α-(allyloxymethyl)acrylate, nonadecyl α-(allyloxymethyl)acrylate, eicosyl α-(allyloxymethyl)acrylate, ceryl α-(allyloxymethyl)acrylate, myricyl α-(allyloxymethyl)acrylate, crotyl α-(allyloxymethyl)acrylate, 1,1-dimethyl-2-propenyl α-(allyloxymethyl)acrylate, 2-methylbutenyl α-(allyloxymethyl)acrylate, 3-methyl-2-butenyl α-(allyloxymethyl)acrylate, 3-methyl-3-butenyl α-(allyloxymethyl)acrylate, 2-methyl-3-butenyl α-(allyloxymethyl)acrylate, oleyl α-(allyloxymethyl)acrylate, linoleyl α-(allyloxymethyl)acrylate, linolenyl α-(allyloxymethyl)acrylate, cyclopentyl α-(allyloxymethyl)acrylate, cyclopentylmethyl α-(allyloxymethyl)acrylate, cyclohexyl α-(allyloxymethyl)acrylate, cyclohexylmethyl α-(allyloxymethyl)acrylate, 4-methylcyclohexyl α-(allyloxymethyl)acrylate, 4-tert-butylcyclohexyl α-(allyloxymethyl)acrylate, tricyclodecanyl α-(allyloxymethyl)acrylate, isobornyl α-(allyloxymethyl)acrylate, adamantyl α-(allyloxymethyl)acrylate, dicyclopentanyl α-(allyloxymethyl)acrylate, dicyclopentenyl α-(allyloxymethyl)acrylate, phenyl α-(allyloxymethyl)acrylate, methylphenyl α-(allyloxymethyl)acrylate, dimethylphenyl α-(allyloxymethyl)acrylate, trimethylphenyl α-(allyloxymethyl)acrylate, 4-tert-butylphenyl α-(allyloxymethyl)acrylate, benzyl α-(allyloxymethyl)acrylate, diphenylmethyl α-(allyloxymethyl)acrylate, diphenylethyl α-(allyloxymethyl)acrylate, triphenylmethyl α-(allyloxymethyl)acrylate, cinnamyl α-(allyloxymethyl)acrylate, naphthyl α-(allyloxymethyl)acrylate, anthracenyl α-(allyloxymethyl)acrylate, methoxyethyl α-(allyloxymethyl)acrylate, methoxyethoxyethyl α-(allyloxymethyl)acrylate, methoxyethoxyethoxyethyl α-(allyloxymethyl)acrylate, 3-methoxybutyl α-(allyloxymethyl)acrylate, ethoxyethyl α-(allyloxymethyl)acrylate, ethoxyethoxyethyl α-(allyloxymethyl)acrylate, cyclopentoxyethyl α-(allyloxymethyl)acrylate, cyclohexyloxyethyl α-(allyloxymethyl)acrylate, cyclopentoxyethoxyethyl α-(allyloxymethyl)acrylate, cyclohexyloxyethoxyethyl α-(allyloxymethyl)acrylate, dicyclopentenyloxyethyl α-(allyloxymethyl)acrylate, phenoxyethyl α-(allyloxymethyl)acrylate, phenoxyethoxyethyl α-(allyloxymethyl)acrylate, glycidyl α-(allyloxymethyl)acrylate, β-methylglycidyl α-(allyloxymethyl)acrylate, β-ethylglycidyl α-(allyloxymethyl)acrylate, 3,4-epoxycyclohexylmethyl α-(allyloxymethyl)acrylate, 2-oxetanylmethyl α-(allyloxymethyl)acrylate, 3-methyl-3-oxetanylmethyl α-(allyloxymethyl)acrylate, 3-ethyl-3-oxetanylmethyl α-(allyloxymethyl)acrylate, tetrahydrofuranyl α-(allyloxymethyl)acrylate, tetrahydrofurfuryl α-(allyloxymethyl)acrylate, tetrahydropyranyl α-(allyloxymethyl)acrylate, dioxazolyl α-(allyloxymethyl)acrylate, and dioxanyl α-(allyloxymethyl)acrylate.

1-1-2. Other Photopolymerizable Monomers

The photopolymerizable monomers may include photopolymerizable monomers other than above-mentioned ones as long as they have a viscosity that can achieve good dischargeability from discharge openings while ensuring the above-mentioned tensile strength and impact resistance. Photopolymerizable monomers other than above-described ones may be used alone or in combination.

Examples of photopolymerizable monomers other than above-described ones include (meth)acrylates that cannot form ring structures in the main chains by polymerization.

Examples of such (meth)acrylates include methyl (meth)acrylate, ethyl (meth)acrylate, propyl (meth)acrylate, butyl (meth)acrylate, 2-ethylhexyl (meth)acrylate, pentyl (meth)acrylate, isoamyl (meth)acrylate, octyl (meth)acrylate, isooctyl (meth)acrylate, isononyl (meth)acrylate, decyl (meth)acrylate, isodecyl (meth)acrylate, lauryl (meth)acrylate, tridecyl (meth)acrylate, isomyristyl (meth)acrylate, isostearyl (meth)acrylate, n-stearyl (meth)acrylate, butoxyethyl (meth)acrylate, methoxyethyl (meth)acrylate, 2-hydroxyethyl (meth)acrylate, 2-hydroxypropyl (meth)acrylate, 2-hydroxybutyl (meth)acrylate, di(ethylene glycol) 2-ethylhexyl ether (meth)acrylate, 4-hydroxybutyl (meth)acrylate, di(ethylene glycol) methyl ether (meth)acrylate, tri(ethylene glycol) methyl ether (meth)acrylate, di(ethylene glycol) ethyl ether (meth)acrylate, 2-(2-ethoxyethoxy)ethyl (meth)acrylate, and 2-ethylhexyl diglycol(meth)acrylate.

1-1-2-1. Pseudo-Crosslinking Monomers

The other photopolymerizable monomers may be a monomer having a pseudo-crosslinking group (hereinafter also simply referred to as “pseudo-crosslinking monomer”). As used herein, the phrase “pseudo-crosslinking group” refers to a functional group that can form a pseudo-crosslink with a bond energy of 1 kJmol⁻¹ or more and less than 100 kJmol⁻¹, or a hydroxyl group, an amide group, or an aromatic group that can form hydrogen bonds or create II-II interactions. As used herein, the phrase “hydroxyl group” refers to a functional group having a monovalent —OH structure. Examples of the hydroxyl groups include a carboxylic acid group and a sulfonic acid group, in addition to a functional group solely composed of a —OH structure. As used herein, the phrase “amide group” refers to a functional group having a trivalent —CON< structure. Examples of the amide groups also include a urea group and a urethane group. The pseudo-crosslinking monomer may be used alone or in combination.

At pseudo-crosslinking points formed from aggregated pseudo-crosslinking groups, linear polymers, which are formed from polymerized photopolymerizable monomers, are non-covalently bonded to each other. Such pseudo-crosslinking structures due to non-covalent bonds enhance tensile strength and impact resistance of a three-dimensional object by linking the linear polymers. Meanwhile, at the pseudo-crosslinking points, the linear polymers are aggregated with relatively weak force, compared with chemical crosslinking through covalent bonds. Accordingly, the movement of the linear polymers is not readily restricted compared with chemical crosslinking, and thus the linear polymers can freely stretch corresponding to stress. As in the foregoing, the pseudo-crosslinking points presumably enhance impact resistance and achieve satisfactory tensile strength in a three-dimensional object.

Moreover, such a pseudo-crosslinking group has higher polarity than the rest segments of a photopolymerizable monomer, and thus tend to be expelled to a surface of each layer during curing of ink layers for three-dimensional fabrication. The pseudo-crosslinking groups expelled to the surface presumably enhance interlaminar strength of a three-dimensional object further by forming pseudo-crosslinking points with pseudo-crosslinking groups of the following layer during the formation of the following layer.

From a viewpoint of further enhancing tensile strength and impact resistance of a three-dimensional object, the content of the pseudo-crosslinking monomer is preferably 5 mass % or more and 70 mass % or less, more preferably 10 mass % or more and 60 mass % or less, further preferably 20 mass % or more and 50 mass % or less, based on the total mass of the photopolymerizable monomer.

Examples of the photopolymerizable monomers having a functional group solely composed of a —OH structure include 2-hydroxy3-phenoxypropyl (meth)acrylate, bisphenol A di(meth)acrylate, bisphenol A-EO adduct di(meth)acrylate, bisphenol A-PO adduct bis(meth)acrylate, hydrogenated bisphenol A-EO adduct di(meth)acrylate, bisphenol A-PO adduct di(meth)acrylate, and 1,4-cyclohexanedimethanol monoacrylate.

Examples of the photopolymerizable monomers having carboxylic acid groups include 2-(meth)acryloyloxyethyl hexahydrophthalate, 2-(meth)acryloyloxyethyl phthalate, 2-(meth)acryloyloxyethyl succinate, N-(meth)acryloyl aspartate, 2-acetoacetoxyetyhl (meth)acrylate, 2-(meth)acryloyloxyethyl hydrogen phthalate, 2-(meth)acryloyloxyethyl hydrogen maleate, 2-(meth)acryloyloxybenzoic acid, 3-(meth)acryloyloxybenzoic acid, 4-(meth)acryloyloxybenzoic acid, 11-(meth)acryloyloxyundecan-1,1-dicarboxylic acid, 10-(meth)acryloyloxydecane-1,1-dicarboxylic acid, 12-(meth)acryloyloxydodecane-1,1-dicarboxylic acid, 6-(meth)acryloyloxyhexyl-1,1-dicarboxylic acid, 2-(meth)acryloyloxyethyl 3′-methacryloyloxy-2′-(3,4-dicarboxybenzoyloxy)propyl succinate, 1,4-bis(2-(meth)acryloyloxyethyl)pyromellitate, 4-(2-(meth)acryloyloxyethyl)trimellitic anhydride, 4-(2-(meth)acryloyloxyethyl) trimellitate, 4-(meth)acryloyloxyethyl trimellitate, 4-(meth)acryloyloxybutyl trimellitate, 4-(meth)acryloyloxyhexyl trimellitate, 4-(meth)acryloyloxydecyl trimellitate, 4-(meth)acryloyloxybutyl trimellitate, 6-(meth)acryloyloxyethyl naphthalene-1,2,6-tricarboxylic anhydride, 6-(meth)acryloyloxyethyl naphthalene-2,3,6-tricarboxylic anhydride, 4-(meth)acryloyloxyethylcarbonylpropionoyl-1,8-naphthalic anhydride, and 4-(meth)acryloyloxyethylnaphthalene-1,4,8-tricarboxylic anhydride.

Examples of the photopolymerizable monomers having sulfonic acid groups include 2-(meth)acrylamido-2-methylpropanesulfonic acid, p-vinylbenzenesulfonic acid, and vinylsulfonic acid.

Examples of the photopolymerizable monomers having amide groups include (meth)acrylamides, such as N-methyl(meth)acrylamide, N,N-dimethyl(meth)acrylamide, N,N-diethyl(meth)acrylamide, N-isopropyl(meth)acrylamide, N-butyl(meth)acrylamide, N-hexyl(meth)acrylamide, aminomethyl(meth)acrylamide, aminoethyl(meth)acrylamide, mercaptomethyl(meth)acrylamide, mercaptoethyl(meth)acrylamide, N-(meth)acryloylmorpholine, N-(meth)acryloylpiperidine, N-(meth)acryloylpyrrolidine, N-vinylformamide, N-vinylacetamide, N-vinyl-2-caprolactam, diacetone (meth)acrylamide, dimethylaminopropyl(meth)acrylamide, hydroxyethyl(meth)acrylamide, N-n-butoxymethyl(meth)acrylamide, and N-[3-(dimethylamino)propyl](meth)acrylamide; 2-(butylcarbamoyloxy)ethyl (meth)acrylate; N-vinylformamide; N-vinylcaprolatam; N-vinylpyrrolidone; dimethylaminoethyl (meth)acrylate; diethylaminoethyl (meth)acrylate; and various amine-modified (meth)acrylates.

Examples of the photopolymerizable monomers having aromatic groups include benzyl (meth)acrylate, phenoxyethyl (meth)acrylate, phenoxyethoxyethyl (meth)acrylate, 2-hydroxy-3-phenoxypropyl (meth)acrylate, 2-(meth)acryloyloxyethyl phthalate, 2-(meth)acryloyloxyethyl 2-hydroxyethyl phthalate, t-butylcyclohexyl (meth)acrylate, 2-(meth)acryloyloxyethyl hexahydrophthalate, bisphenol A di(meth)acrylate, bisphenol A-EO adduct di(meth)acrylate, bisphenol A-PO adduct di(meth)acrylate, hydrogenated bisphenol A-EO adduct di(meth)acrylate, phenyl allyl ether, o-,m-, or p-cresol monoallyl ether, biphenyl-2-ol monoallyl ether, biphenyl-4-ol monoallyl ether, phenyl vinyl ether, benzyl vinyl ether, phenylmaleimide, polyethylene glycol phenyl glycidyl ether, butylphenyl glycidyl ether, glycidyl hexahydrophthalate, 3-(2-phenoxyethyl)-3-ethyloxetane.

1-1-2-2. Polyfunctional Photopolymerizable Monomers

The other photopolymerizable monomers may be a polyfunctional photopolymerizable monomer (hereinafter also simply referred to as “polyfunctional monomer”). Chemical crosslinking of polyfunctional monomers through covalent bonds can further enhance tensile strength of a three-dimensional object by strongly linking linear polymers formed from polymerized photopolymerizable monomers. As used herein, the phrase “polyfunctional monomer” refers to a monomer having, in a molecule, two or more functional groups selected from radical polymerizable functional groups and cationic polymerizable functional groups. From a viewpoint of facilitating chemical crosslinking, the polyfunctional monomer preferably has, in a molecule, two or more radical polymerizable functional groups or two or more cationic polymerizable functional groups. The polyfunctional monomer may be used alone or in combination.

When the photopolymerizable monomers include a polyfunctional monomer, the content of the polyfunctional monomer is preferably more than 0 mass % and 30 mass % or less, based on the total mass of the photopolymerizable monomers, from a viewpoint of achieving satisfactory tensile strength of a three-dimensional object. Setting the content of the polyfunctional monomer to 30 mass % or less can further suppress curing shrinkage of a three-dimensional object due to the presence of a large number of chemical crosslinks. In view of the above, the content of the polyfunctional monomer is preferably more than 0 mass % and 20 mass % or less, more preferably more than 0 mass % and 10 mass % or less. When achieving satisfactory tensile strength is emphasized, the model material ink preferably does not substantially contain a polyfunctional monomer. As used herein, the phrase “does not substantially contain” refers to the content of the polyfunctional monomer of 0.1 mass % or less, based on the total mass of the photopolymerizable monomers. Accordingly, the content of the polyfunctional monomer is preferably adjusted in accordance with the uses and required characteristics of a three-dimensional object to be fabricated.

Examples of the polyfunctional monomers include polyfunctional (meth)acrylates.

Examples of the polyfunctional (meth)acrylates include bifunctional (meth)acrylates, such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethyloltricyclodecane di(meth)acrylate, bisphenol A-PO adduct di(meth)acrylate, neopentyl glycol hydroxypivalate di(meth)acrylate, and polytetramethylene glycol di(meth)acrylate; and tri- or higher-functionality (meth)acrylates, such as trimethylolpropane tri(meth)acrylate, pentaerythritol tri(meth)acrylate, pentaerythritol tetra(meth)acrylate, dipentaerythritol hexa(meth)acrylate, di(trimethylolpropane) tetra(meth)acrylate, propoxylated glycerol tri(meth)acrylate, and ethoxylated pentaerythritol tetra(meth)acrylate.

1-1-2-3. Photopolymerizable Monomers Having Nonaromatic Cyclic Hydrocarbon Structures

The photopolymerizable monomers may include a photopolymerizable monomer having a nonaromatic cyclic hydrocarbon structure (hereinafter also simply referred to as “cyclic hydrocarbon monomer”). Examples of the nonaromatic cyclic hydrocarbon structures (hereinafter also simply referred to as “alicyclic ring or the like”) include an alicyclic structure whose ring structure is solely composed of carbon and hydrogen, a heterocyclic structure whose ring structure contains carbon and other atoms, and a spiro ring structure, a plurality of whose ring structures share one atom. When the photopolymerizable monomers include the cyclic hydrocarbon monomer, the movement of linear polymers is obstructed due to steric effects of the alicyclic ring or the like, and consequently impact resistance, heat resistance, and water resistance of a three-dimensional object can be enhanced further. This can suppress deformation of a three-dimensional object due to absorbed water, and thus further reduce deformation of the three-dimensional object after fabrication. The cyclic hydrocarbon monomer may be used alone or in combination.

From a viewpoint of further lowering water absorption by a three-dimensional object, the content of the cyclic hydrocarbon monomer is preferably 5 mass % or more and 40 mass % or less, more preferably 5 mass % or more and 30 mass % or less, and further preferably 10 mass % or more and 25 mass % or less, based on the total mass of the photopolymerizable monomers.

Examples of the cyclic hydrocarbon monomers include cyclohexyl (meth)acrylate, isobornyl (meth)acrylate, dicyclopentenyl (meth)acrylate, dicyclopentanyl (meth)acrylate, 4-acryloylmorpholine, tetrahydrofurfuryl (meth)acrylate, 1,4-cyclohexanedimethanol mono(meth)acrylate, cyclohexyl allyl ether, cyclohexanemethanol monoallyl ether, cyclohexyl vinyl ether, cyclohexylmaleimide, adamantyl vinyl ether, 1,2-epoxycyclohexane, 1,4-epoxycylohexane, 1,2-epoxy-4-vinylcyclohexane, and norbornene oxide.

1-2. Polymers

The polymer is a molecule with a weight-average molecular weight of 5,000 or more and 80,000 or less that is composed of repeatedly arranged one or more carbon-containing structural segments. The polymer can enhance tensile strength and impact resistance of a three-dimensional object to be formed. The polymer may be used alone or in combination.

By setting a weight-average molecular weight of the polymer to 5,000 or more, tensile strength and impact resistance of a three-dimensional object can be further enhanced due to satisfactory phase separation between the photopolymerizable monomer and the polymer. Meanwhile, by setting a weight-average molecular weight of the polymer to 80,000 or less, satisfactory ejection properties of an ink from nozzles of an inkjet head can be achieved since the viscosity of a model material ink does not increase excessively. From a viewpoint of achieving high tensile strength and impact resistance of a three-dimensional object as well as a low viscosity of an ink, a weight-average molecular weight of the polymer is preferably 6,000 or more and 70,000 or less, more preferably 7,000 or more and 30,000 or less.

The content of the polymer in a model material ink may be in a range to cause the above-mentioned phase separation, and can be 1 mass % or more and 45 mass % or less, for example, based on the total mass of the model material ink. From a viewpoint of further enhancing impact resistance and tensile strength of a three-dimensional object, the content of the polymer is more preferably 5 mass % or more. From a viewpoint of further enhancing tensile strength of a three-dimensional object, the content of the polymer is more preferably 35 mass % or less. From a viewpoint of achieving both higher impact resistance and higher tensile strength, the content of the polymer is further preferably 10 mass % or more and 25 mass % or less.

The occurrence of phase separation between the photopolymerizable monomer and the polymer in a fabricated three-dimensional object can be confirmed when two peaks (inflection points) are observed in a graph of tan δ (which represents a ratio of loss modulus and storage modulus) obtained through measurement of elasticity values of the three-dimensional object using an ARES-G2 rheometer (from TA Instruments).

As an absolute value, a difference between a solubility parameter (hereinafter also simply referred to as “SP value”) of the polymer and a SP value of the photopolymerizable monomer is 0.30 (cal/cm³)^{1/2} or more and 2.0 (cal/cm³)^{1/2} or less. When a model material ink contains two or more polymers in combination, the above-mentioned SP value of the polymer indicates a SP value of the polymers as a whole, and when a model material ink contains two or more photopolymerizable monomers in combination, the above-mentioned SP value of the photopolymerizable monomer indicates a SP value of the photopolymerizable monomers as a whole. According to the findings newly made by the present inventors, when the difference between the SP values is 0.30 (cal/cm³)^{1/2} or more, the polymer and the photopolymerizable monomer are incompatible and thus form a phase separation structure, thereby enhancing tensile strength and impact resistance of a three-dimensional object. Meanwhile, the difference between the SP values is 2.0 (cal/cm³)^{1/2} or less, the polymer and the photopolymerizable monomer are not excessively separated and thus form an islands-in-the sea structure, where fine particles of the polymer are scattered in the photopolymerizable monomer, thereby enhancing tensile strength and impact resistance of a three-dimensional object. In view of the above, the difference between the SP values is preferably 0.30 (cal/cm³)^{1/2} or more and 1.5 (cal/cm³)^{1/2} or less, more preferably 0.30 (cal/cm³)^{1/2} or more and 1.0 (cal/cm³)^{1/2} or less.

SP values of the photopolymerizable monomer and the polymer are calculated through Bicerano method, which estimates the values using a regression equation obtained by statistically analyzing a correlation between a molecular structure and physical properties of a polymer material. Specifically, employed are values calculated through Bicerano method using “Scigress Version 2.6” software (from Fujitsu Limited) installed in a commercial personal computer by inputting a structure of each compound. When two or more polymers are combined, as a SP value of the polymers as a whole, employed is a SP value of a copolymer of the polymers, which is obtained by substituting volume fractions φₖ and SP values δₖ of the respective n types of polymers for equation 1. When two or more photopolymerizable monomers are combined, as a SP value of the photopolymerizable monomers as a whole, employed is a SP value of a copolymer of the photopolymerizable monomers, which is obtained by substituting volume fractions φₖ and SP values δk of the respective photopolymerizable monomers for equation 1.

$$SP value = {( {\sum }_{k = 1}^{n} ( {φ}_{k} {δ}_{k}^{2} ) )}^{1 / 2} \qquad ( Equation 1 )$$

1-2-1. Polymers Having Photopolymerizable Groups

When the polymer has 1 molar equivalent or more of a photopolymerizable group, relative to 1 mole of the polymer, impact resistance of a three-dimensional object can be enhanced further. This is presumably due to the following reasons. When a model material ink containing such a polymer is irradiated with actinic radiation, covalent bonds are also formed between the polymer and the photopolymerizable monomer. This facilitates the formation of a fine phase separation structure due to penetration of particles of the polymer into between linear polymers, and enhances interfacial strength of the polymer particles by the covalent bonds, thereby suppressing decomposition of the polymer particles. Since a fine phase separation structure is thus formed, impact resistance of a three-dimensional object is presumably enhanced further. Examples of the photopolymerizable groups that the polymer can have include the above-mentioned photopolymerizable groups. From a viewpoint of preventing compatibility between the polymer and the photopolymerizable monomer by the crosslinker-like behavior of the polymer, the polymer preferably has 1 molar equivalent or more and 10 molar equivalent or less of a photopolymerizable group, more preferably 1 molar equivalent or more and 4 molar equivalent or less of a photopolymerizable group, relative to 1 mole of the polymer. The polymer having a photopolymerizable group may be used alone or in combination.

In view of the above, the content of the polymer having a photopolymerizable group is preferably 2 mass % or more and 40 mass % or less, more preferably 5 mass % or more and 30 mass % or less, and further preferably 10 mass % or more and 25 mass % or less.

From a viewpoint of facilitating the formation of the above-mentioned covalent bonds, a photopolymerizable group is preferably present at a terminal of the polymer. For example, a photopolymerizable group can be introduced to a terminal of the polymer by using a compound having a reactive portion with the polymer and a photopolymerizable group as a reaction terminator when the polymer is prepared through polymerization of monomers.

From a viewpoint of further enhancing tensile strength, preferably, the polymer has 2 molar equivalent or more of a photopolymerizable group, relative to 1 mole of the polymer, and the photopolymerizable compounds include the above-mentioned polyfunctional monomer. Such a combination produces more crosslinked portions in viscous polymer domains, and thus tensile strength is presumably enhanced further.

A molar equivalent of the photopolymerizable group of the polymer can be obtained by dividing an amount of the photopolymerizable group of the polymer in a three-dimensional object by a weight-average molecular weight of the polymer. The amount of the photopolymerizable group can be estimated utilizing common analysis methods, such as nuclear magnetic resonance (NMR), Fourier transform infrared spectroscopy (FT-IR), and mass spectrometry (MS). A weight-average molecular weight of the polymer can be measured by performing gel permeation chromatography (GPC) using a column and o-dichlorobenzene as a solvent, and substituting the obtained values for a calibration curve of polystyrene.

Further, the amount of the photopolymerizable group of the polymer and the weight-average molecular weight of the polymer in an already fabricated three-dimensional object can be identified by analyzing a sample of the three-dimensional object through common analysis methods, such as NMR, FT-IR, and MS.

1-2-2. Polymers Having Structural Segment Compatible with Photopolymerizable Monomer and Structural Segment Incompatible with Photopolymerizable Monomer

When the polymer has a structural segment compatible with the photopolymerizable monomer and a structural segment incompatible with the photopolymerizable monomer, tensile strength and impact resistance of a three-dimensional object can be enhanced further, and the viscosity of a model material ink can also be lowered to a more suitable range for inkjet discharge. This is presumably due to the following reasons. When a model material ink containing such a polymer is irradiated with actinic radiation, the structural segment incompatible with the photopolymerizable monomer produces a phase-separation structure while the structural segment compatible with the photopolymerizable monomer facilitates penetration of the polymer into between linear polymers, and consequently the phase-separation structure tends to become finer. A finer phase-separation structure disperses stress or impact in the tensile direction more finely, and thus suppresses concentration of stress or impact at a specific point in a three-dimensional object, thereby further enhancing tensile strength and impact resistance of the three-dimensional object. Moreover, when the polymer has a portion compatible with the photopolymerizable monomer in the molecule, the polymer and the photopolymerizable monomer become moderately compatible, and the viscosity of a model material ink is further lowered. The polymer may be used alone or in combination.

Examples of the structural segments compatible with the photopolymerizable monomer include a urethane linkage, a urea linkage, an acrylate group, a carbonate group, an ester group, and an ether group. Among them, from a viewpoint of aggregating the polymer through self-aggregation of such segments, and facilitating phase separation between the photopolymerizable monomer and the polymer, the polymer preferably has a urethane linkage, a carbonate group, an ester group, and/or an ether group. From a viewpoint of enhancing impact resistance by lowering a Tg of the polymer and thus increasing a difference between the Tg of the polymer and a Tg of the photopolymerizable monomer, thereby facilitating the occurrence of crazing, the polymer preferably has a urethane linkage.

Examples of the structural segments incompatible with the photopolymerizable monomer include a C_{≧4} hydrocarbon group. The hydrocarbon group may be linear or branched, and may contain a double bond. From a viewpoint of further enhancing impact resistance by lowering a Tg of the polymer and thus increasing a difference between the Tg of the polymer and a Tg of the photopolymerizable monomer, thereby facilitating the occurrence of crazing, the polymer preferably has a hydrocarbon group composed of a C_{≧4} linear hydrocarbon containing a double bond.

From a viewpoint of facilitating the formation of a fine phase separation structure and further enhancing impact resistance, the polymer is preferably a urethane polymer having a plurality of urethane linkages, and preferably has a carbonate group.

By using a urethane polymer and a compound having the structure of formula 1 in combination, tensile strength and impact resistance of a three-dimensional object can be enhanced further. Ring structures in the main chain formed by polymerizing the compound having the structure of formula 1 exhibit polarity due to oxygen atoms contained. Interactions between the ring structures with polarity and urethane linkages with polarity strengthen the interfaces of the islands-in-the-sea structure, and consequently tensile strength and impact resistance of a three-dimensional object is presumably enhanced further.

1-3. Photopolymerization Initiators

The photopolymerization initiator is a radical photoinitiator when the photopolymerizable monomer is a compound having a radical polymerizable functional group, and a photoacid generator when the photopolymerizable monomer is a compound having a cationic polymerizable functional group. The photopolymerization initiator may be one initiator, in combination with other initiators, or a combination of a radical photoinitiator and a photoacid generator.

The radical photoinitiators include a cleavage-type radical initiator and a hydrogen abstraction-type radical initiator. A model material ink preferably contains at least a cleavage-type photopolymerization initiator. In other words, the model material ink may contain both cleavage-type and hydrogen abstraction-type photopolymerization initiators, or may contain only a cleavage-type photopolymerization initiator.

When a model material ink contains both the cleavage-type and the hydrogen abstraction-type initiators, the mass of the cleavage-type initiator is preferably larger than the mass of the hydrogen abstraction-type initiator. A proportion of the hydrogen abstraction-type initiator included in the photopolymerization initiators is preferably 30 mass % or less, more preferably 20 mass % or more and 30 mass % or less.

When a model material ink contains both the cleavage-type and hydrogen abstraction-type radical photoinitiators as photopolymerization initiators, a curing rate of the model material ink increases. While the reasons are not fully understood, it is believed that when a cleavage-type radical initiator and a hydrogen abstraction-type radical initiator are present together as photopolymerization initiators, the hydrogen abstraction-type radical initiator, as a polymerization initiator, functions like a sensitizer, thereby increasing a polymerization rate.

In contrast, when a model material ink does not substantially contain a hydrogen abstraction-type radical photoinitiator, tensile strength of a three-dimensional object tends to become high. Although the reasons are not fully understood, this is presumably due to the following. Irregular crosslinks sometimes arise when the hydrogen abstraction-type radical photoinitiator triggers graft polymerization among linear polymers, which are obtained through polymerization of a photopolymerizable monomer. When such irregular crosslinks exist in a three-dimensional object, stress is concentrated in a specific portion in the composition upon elongation of a cured article, and thus the three-dimensional object yields without fully stretching. When a model material ink does not substantially contain the hydrogen abstraction-type radical photoinitiator, however, the above-mentioned graft polymerization is not readily triggered, and consequently tensile strength tends to become high.

Therefore, when acceleration of the production speed of a three-dimensional object is required, a model material ink preferably contains both the cleavage-type radical initiator and the hydrogen abstraction-type radical initiator. Meanwhile, when the durability of a three-dimensional object is emphasized, the hydrogen abstraction-type radical initiator is preferably not substantially contained.

Examples of the cleavage-type radical initiators include acetophenone-type radical initiators, such as diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy)phenyl (2-hydroxy-2-propyl) ketone, 1-hydroxycyclohexyl phenyl ketone, 2-methyl-2-morpholino (4-thiomethylphenyl)propane-1-one, and 2-benzyl-2-diemthylamino-1-(4-morpholinophenyl)butanone; benzoin derivative radical initiators, such as benzoin, benzoin methyl ether, and benzoin isopropyl ether; acylphosphine oxide-type radical initiators, such as 2,4,6-trimethylbenzoyldiphenylphosphine oxide; benzil; and methyl phenylglyoxylate.

Examples of the hydrogen abstraction-type radical initiators include benzophenone derivatives, such as benzophenone and N,N-diethylbenzophenone; thioxanthone derivatives, such as 2,4-diethylthioxanthone, isopropylthioxanthone, chlorothioxanthone, and isopropoxychlorothioxanthone; anthraquinone derivatives, such as ethylanthraquinone, benzanthraquinone, aminoanthraquinone, and chloroanthraquinone; and acridine derivatives, such as 9-phenylacridine, and 1,7-bis(9,9′-acridinyl)heptane.

Examples of the photoacid generators include commonly known sulfonium salts, ammonium salts, diaryliodonium salts, and triarylsulfonium salts. Specific examples include triarylsulfonium hexafluorophosphate salts, (4-methylphenyl) [4-(2-methylpropyl)phenyl]iodonium hexafluorophosphate, triarylsulfonium hexafluoroantimonate, and 3-methyl-2-butenyltetrahydrothiophenium hexafluoroantimonate. Examples of commercially available photoacid generators include UVI-6990 (from Bayer AG), UVACURE 1591 (from DAICEL-ALLNEX LTD., “UVACURE 1591” is a trademark of Allnex Holding S.à r.l.), CGI-552, Ir 250 (from BASF SE), SP-150, SP-152, SP-170, SP-172, CP-77 (from Asahi Denka Kogyo K.K.), CPI-100P, CPI-101A, CPI-200K, and CPI-210S (from San-Apro Ltd.).

Although depending on types or the like of actinic radiation and/or actinic radiation-curable compounds, the content of the photopolymerization initiator is preferably 0.01 mass % or more and 10 mass % or less, based on the total mass of a model material ink.

1-4. Other Components

A model material ink may further contain other components, such as a sensitizer, a photopolymerization initiator auxiliary agent, a polymerization inhibitor, and a release promotor, as long as the above-mentioned tensile strength, impact resistance, and dischargeability are satisfactorily achieved. These components may be used alone or in combination.

Examples of the sensitizers include a sensitizer that exhibits sensitizing function by light with a wavelength of 400 nm or longer. Examples of such sensitizers include anthracene derivatives, such as 9,10-dibutoxyanthracene, 9,10-diethoxyanthracene, 9,10-dipropoxyanthracene, and 9,10-bis(2-ethylhexyloxy)anthracene. Examples of commercially available sensitizers include DBA and DEA (from KAWASAKI KASEI CHEMICALS LTD.).

Examples of the photopolymerization initiator auxiliary agents include aromatic tertiary amine compounds and other tertiary amine compounds. Examples of the aromatic tertiary amine compounds include N,N-dimethylaniline, N,N-diethylaniline, N,N-dimethyl-p-toluidine, ethyl p-N,N-dimethylaminobenzoate, isoamylethyl p-N,N-dimethylaminobenzoate, N,N-bis(hydroxyethyl)aniline, triethylamine, and N,N-dimethylhexylamine.

Examples of the polymerization inhibitors include (alkyl)phenol, hydroquinone, catechol, resorcin, p-methoxyphenol, t-butylcatechol, t-butylhydroquinone, pyrogallol, 2,2-Diphenyl-1-picrylhydrazyl, phenothiazine, p-benzoquinone, nitrosobenzene, 2,5-di-t-butyl-p-benzoquinone, bis(dithiobenzoyl) disulfide, picric acid, cupferron, N-nitrosophenylhydroxyl amine aluminum salt, tri-p-nitrophenylmethyl, N-(3-oxyanilino-1,3-dimethylbutylidene)aniline oxide, dibutylcresol, cyclohexanone oxime cresol, guaiacol, o-isopropylphenol, butyraldehyde oxime, methyl ethyl ketone oxime, and cyclohexanone oxime.

In three-dimensional fabrication by an inkjet method, a three-dimensional object is fabricated while a model material layer during fabrication is supported by a support material layer, which is formed by curing an ink composition for formation of a support region (hereinafter also simply referred to as “support material ink”). In such a case, the release promotor further facilitates release of the support material layer from the model material layer. Examples of the release promotors include silicone surfactants, fluorine-based surfactants, and higher fatty acid esters, such as stearyl sebacate. From a viewpoint of further facilitating the release, the release promotor is preferably a silicone surfactant. The content of the release promotor is preferably 0.01 mass % or more and 3.0 mass % or less, based on the total mass of an ink. By setting the content of the release promotor to 0.01 mass % or more, releasability of a substrate from a three-dimensional object can be enhanced further. Meanwhile, by setting the content of the release promotor to 3.0 mass % or less, suppressed can be the occurrence of distortion of the shape of a three-dimensional object due to coalesced droplets of a model material ink before curing.

2. Ink Sets

The above-mentioned model material ink and the support material ink can be combined as an ink set. The ink set may be in any form as long as the model material ink and the support material ink are packaged together, sold, and used for the formation of one three-dimensional object. For example, the model material ink and the support material ink may be stored separately in a plurality of ink cartridges, or an ink cartridge may be configured as one body from a plurality of ink reservoir sections, each of which stores the model material ink or the support material ink.

2-1. Support Material Inks

From a viewpoint of facilitating the removal, the support material ink is preferably an ink that undergoes temperature-dependent solidification and heat melting of the resulting solid, or a photocurable ink whose cured article is water soluble or water swellable.

Examples of the support materials that undergo temperature-dependent solidification and heat melting of the resulting solid include waxes, such as a paraffin wax, a microcrystalline wax, carnauba wax, an ester wax, an amide wax, and PEG 20000.

Examples of the photocurable support materials whose cured articles are water soluble or water swellable include a photocurable resin composition containing a water-soluble compound having a photopolymerizable functional group, a cleavage-type radical initiator, and water as main components. The support material may further contain a water-soluble polymer.

Examples of the water-soluble compounds having photopolymerizable functional groups, which can be contained in the support material ink, include water-soluble (meth)acrylates, such as polyoxyethylene di(meth)acrylate, polyoxypropylene di(meth)acrylate, (meth)acryloylmorpholine, and a hydroxyalkyl (meth)acrylate; and water-soluble (meth)acrylamides, such as (meth)acrylamide, N,N-dimethyl(meth)acrylamide, and N-hydroxyethyl(meth)acrylamide. Examples of the cleavage-type radical initiators contained in the support material include the above-mentioned compounds. Examples of the water-soluble polymers, which can be contained in the support material, include polyethylene glycol, polypropylene glycol, and polyvinyl alcohol.

3. Fabrication Method of Three-Dimensional Objects

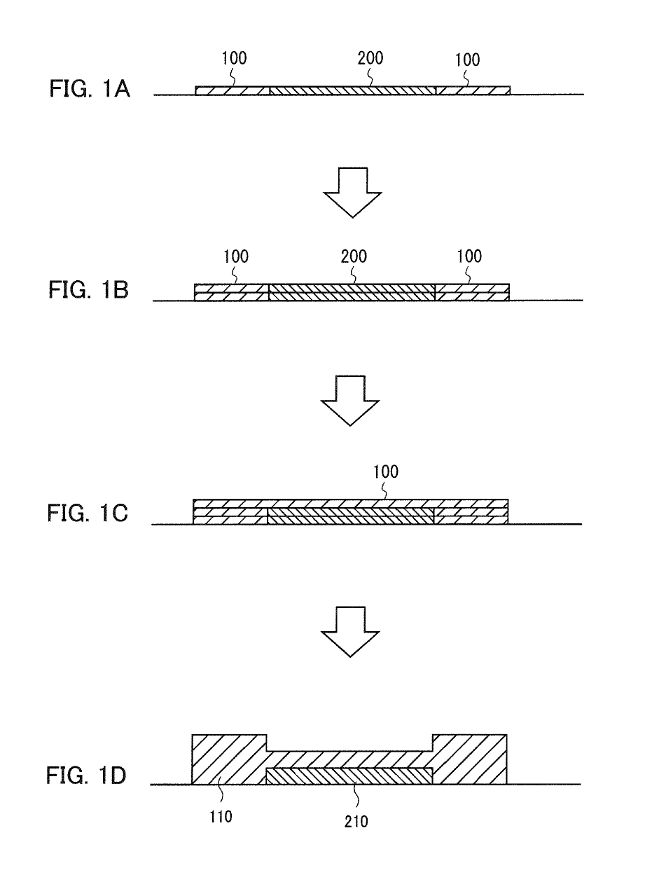

As illustrated in FIGS. 1A to 1D, the method of fabricating a three-dimensional object according to the embodiment, using the above-mentioned model material ink, includes forming a first ink layer region containing a portion of the model material ink by discharging the model material ink from nozzles of an inkjet head, and forming a model material layer region by irradiating with actinic radiation of the portion of the model material ink contained in the formed first ink layer (FIG. 1A). Discharging, curing, stacking, and the like of an ink can be performed in substantially the same manner as a commonly known method of fabricating a three-dimensional object through discharge of a photocurable ink composition for three-dimensional fabrication by an inkjet method. As used herein, the phrase “ink layer” refers to a layer formed from a discharged model material ink and an optionally discharged support material ink. By irradiating a portion of the model material ink in the ink layer with actinic radiation, formed is model material layer region 100, which is a layer of narrowly sliced thin piece of a three-dimensional object to be fabricated. As illustrated in FIGS. 1B to 1D, a three-dimensional object is produced by stacking model material layers.

3-1. Step of Forming Ink Layer Containing Portion of Model Material Ink by Discharging Model Material Ink

A model material ink forms a portion of the model material ink in an ink layer by being discharged at predetermined positions, based on data about positions where a model material occupies in each layer of a three-dimensional object to be fabricated. The model material ink is discharged to impact on a substrate, on a model material layer region already formed by irradiation with light, or on an optionally formed support material layer region. The portion of the model material ink contained in each ink layer is cured by irradiation with actinic radiation in a later step, thereby forming a model material layer region.

From a viewpoint of further enhancing ejection properties from nozzles, the volume of one droplet of the model material ink is preferably 1 pL or more and 70 pL or less. From a viewpoint of obtaining a three-dimensional object with higher resolution, the volume of one droplet of the model material ink is more preferably 2 pL or more and 50 pL or less.

3-2. Step of Producing Model Material Layer by Irradiation with Actinic Radiation of Portion of Model Material Ink Contained in Formed Ink Layer

A discharged model material ink can be cured by irradiation with actinic radiation using a light source. Examples of actinic radiation that can be used for curing the model material ink include UV rays and electron beams.

Examples of the light sources for UV irradiation include a fluorescent lamp, such as a low-pressure mercury lamp or a germicidal lamp, a cold cathode tube, a UV laser, a mercury lamp with an operating pressure in the range of 100 Pa or higher and 1 MPa or lower, a metal halide lamp, and a light emitting diode (LED). From a viewpoint of curing a three-dimensional object faster, the light source is preferably a high-pressure mercury lamp, a metal halide lamp, or a LED that enables UV irradiation at an irradiance of 100 mW/cm² or higher, and among them, a LED is preferred from a viewpoint of further reducing power consumption. Specific examples of the LEDs include a 395 nm water-cooled LED (from Phoseon Technology).

Examples of electron beam generation methods include a scanning mode, a curtain beam mode, and a broad beam mode. Among them, a curtain beam mode is preferred from a viewpoint of generating electron beams more efficiently. Examples of the light sources that enable electron beam irradiation include Curetron EBC-200-20-30 (from Nissin High Voltage Co., Ltd.) and Min-EB (from AI Technology, Inc.).

When the actinic radiation is an electron beam, an accelerating voltage in electron beam irradiation is preferably 30 kV or higher and 250 kV or lower, more preferably 30 kV or higher and 100 kV or lower, from a viewpoint of performing satisfactory curing. Moreover, from a viewpoint of performing satisfactory curing, the irradiation dose of electron beams is preferably 30 kGy or higher and 100 kGy or lower, more preferably 30 kGy or higher and 60 kGy or lower. From a viewpoint of enhancing interlayer adhesion between upper and lower layers, the intensity may be set so that the irradiated model material ink remains in a semi-cured state without complete curing, and then the model material ink in the semi-cured state is completely cured during irradiation of the model material ink discharged later with actinic radiation.

From a viewpoint of further suppressing coalescence of adjacent droplets of the model material ink, the droplets of the model material ink are preferably irradiated with actinic radiation within 10 seconds after the impact on a recording medium. In view of the above, the droplets of the model material ink are preferably irradiated with actinic radiation within 0.001 second to 5 seconds, more preferably within 0.01 second to 2 seconds after the impact.

From a viewpoint of facilitating the formation of the following layer, the surface of the model material ink cured through light irradiation may be leveled with a thickness control roller or the like.

3-3. Step of Forming Ink Layer Containing Portion of Support Material Ink by Discharging Support Material Ink from Nozzles of Inkjet Head

The fabrication method of the embodiment may further include discharging a second ink composition from nozzles of a second inkjet head, and forming a second ink layer region. The support material ink forms a second ink layer region (which later becomes a support material layer region) by being discharged, based on data about desirable positions where a support material is disposed in each layer of a three-dimensional object (to be fabricated) to support a model material to be formed afterward. The support material ink is then hardened/cured to form the support material layer (numeral 200 in FIG. 1A). A hollow space portion of a three-dimensional object during fabrication is filled with a support material, which is composed of stacked support material layers, and thus the model material layers during fabrication are supported by the support material from the lower portion in the gravity direction (see FIGS. 1B, 1C, and 1D). Accordingly, the support material can prevent gravity-caused fracture of a three-dimensional object during fabrication due to its portion of the model material layers that have not yet attained satisfactory strength.

The support material layer region may be formed independently from the model material layer region. From a viewpoint of shortening fabrication time, however, the model material layer region and the support material layer region in one ink layer are preferably formed simultaneously. Specifically, a model material ink and a support material ink are discharged simultaneously or continuously to form one ink layer. After the formation of the ink layer or during the formation of the ink layer, the model material layer and the support material layer are formed by irradiating the formed ink layer with actinic radiation. The following ink layers are formed by discharging the model material ink or the support material ink on the formed model material layer or the support material layer.

In this step, an inkjet head may be configured to have nozzles for the support material ink and nozzles for the model material ink such that the model material ink and the support material ink are discharged from the same inkjet head, or the model material ink and the support material ink may be discharged from different inkjet heads. From a viewpoint of shortening fabrication time, it is preferred to connect reservoir sections (that store respective inks) with different inkjet heads through channels, and discharge the model material ink and the support material ink independently from nozzles of different inkjet heads.

3-4. Step of Removing Support Material Layers

When the fabrication method of the embodiment includes discharging the support material ink, the support material is removed after all the model material layer regions and the support material layer regions have been formed.

When a support material that undergoes temperature-dependent hardening and heat melting of the hardened article is used, the support material can be removed, for example, by retaining a support material-attached three-dimensional object under an environment at 60° C. or higher and 130° C. or lower for 1 minute or longer and 5 minutes or shorter. Meanwhile, when a support material that is photocurable and forms a water-soluble or water-swellable cured article is used, the support material can be removed, for example, by immersing a support material-attached three-dimensional object in water at 30° C. or higher and +30° C. or lower relative to Tg of the support material for 10 minutes or longer and 60 minutes or shorter, or by leaving a support material-attached three-dimensional object to stand still under an environment at 40° C. or higher and 70° C. or lower and relative humidity of 50% or higher and 90% or lower for 10 minutes or longer and 60 minutes or shorter.

### Examples

Hereinafter, the present invention will be more specifically described with reference to the examples. The examples, however, shall not be construed as limiting the technical scope of the present invention.

1. Preparation of Model Material Inks

1-1. Monomer Compositions

Monomer compositions 1 to 10 were prepared by mixing photopolymerizable monomers shown in Table 1 in the amounts according to the composition shown in Table 2.

In Table 2, the numbers in the columns of “Ring-forming Monomer” and “Other Monomer” represent the amounts (mass %) of the photopolymerizable monomers shown in Table 1 contained in the monomer compositions.

In Table 1, the numbers in the column of “SP Value” are SP values δₖ estimated through Bicerano method by inputting a structure of each compound into “Scigress Version 2.6” software (from Fujitsu Limited) installed in a commercial personal computer. In Table 2, the numbers in the column of “SP Value” are values obtained by substituting SP value δₖ of each monomer constituting monomer compositions and volume fraction φₖ obtained from the molecular weight and content (mass %) of the monomer for equation 1.

TABLE 1
Photopolymerizable Monomer

| | | SP Value | |
|---|---|---|---|
| Photocurable Monomer | Abbreviation | (cal/cm³)^{1/2} | |
| Methyl α-(allyloxymethyl)acrylate | AOMA-M | 9.19 | Ring-forming Monomer |
| Benzyl α-(allyloxymethyl)acrylate | AOMA-Bz | 9.58 | Ring-forming Monomer |
| Cyclohexyl α-(allyloxymethyl)acrylate | MOMA-CH | 8.83 | Ring-forming Monomer |
| Trimethylolpropane triacrylate | TMPTA | 9.01 | Other Monomer |
| | | | (Polyfunctional Monomer) |
| Bisphenol A epoxy diacrylate | BPAEDA | 11.25 | Other Monomer |
| | | | (pseud-crosslinking Monomer, |
| | | | Polyfunctional Monomer) |
| Dicyclopentanyl acrylate | DCPA | 8.68 | Other Monomer |
| | | | (Cyclic Hydrocarbon Monomer) |
| Dimethylacrylamide | DMAA | 11.05 | Other Monomer |
| | | | (Pseudo-crosslinking Monomer) |
| 4-Acryloylmorpholine | ACMO | 10.96 | Other Monomer |
| | | | (Pseudo-crosslinking Monomer, |
| | | | Cyclic Hydrocarbon Monomer) |
| 2-Hydroxy-3-phenoxypropyl acrylate | HPPA | 11.78 | Other Monomer |
| | | | (Pseudo-crosslinking Monomer) |

TABLE 2
Monomer Compositions No. 1 to 10

| | | Monomer Composition No. | | | | | | | | | |
|---|---|---|---|---|---|---|---|---|---|---|---|
| | | 1 | 2 | 3 | 4 | 5 | 6 | 7 | 8 | 9 | 10 |
| Ring-forming | AOMA-M | 60 | 20 | 60 | 40 | 40 | | | | 15 | |
| Monomer | AOMA-Bz | | | | | | 50 | | 40 | 15 | |
| | AOMA-CH | | 50 | | | | | 50 | | 15 | |
| Other Monomer | TMPTA | 10 | | 25 | | 10 | | | | | 10 |
| | BPAEDA | | 10 | | | | 10 | | | | |
| | DCPA | | 20 | 15 | 10 | 20 | 30 | | | | 90 |
| | DMAA | 30 | | | 10 | | | | | 5 | |
| | ACMO | | | | 20 | 25 | 5 | 30 | | | |
| | HPPA | | | | 20 | 5 | 5 | 20 | 60 | 50 | |

| | | | | | | | | | | |
|---|---|---|---|---|---|---|---|---|---|---|
| Total (mass %) | 100 | 100 | 100 | 100 | 100 | 100 | 100 | 100 | 100 | 100 |
| SP Value (cal/cm³)^{1/2} | 9.77 | 9.14 | 9.07 | 10.28 | 9.69 | 9.70 | 10.13 | 10.95 | 10.66 | 8.48 |

1-2. Polymers

1-2-1. Preparation of Urethane Polymers 1 and 14

A polycarbonate diol ETERNACOLL UH-200 with a weight-average molecular weight of about 2,000 (from Ube Industries, Ltd., “ETERNACOLL” is a registered trademark of the firm) and isophorone diisocyanate were mixed in a molar ratio of 1:1. Toluene and a tin catalyst were further added to the resulting mixture and heated to 70° C. After 5 hours, hydroxyethyl acrylate as a reaction terminator was added to the reaction mixture in a molar ratio to the polycarbonate diol of 4:1, and the mixture was left still for 2 hours to yield urethane polymer 0 with a weight-average molecular weight of 13,000 and a functional group equivalent of 2.

Urethane polymer 14 with a weight-average molecular weight of 13,000 and a functional group equivalent of 0 was obtained in substantially the same manner as urethane polymer 0 except for changing the reaction terminator to ethanol.

Urethane polymer 1 with a weight-average molecular weight of 13,000 and a functional group equivalent of 1 was obtained by mixing urethane polymer 0 and urethane polymer 14 in a molar ratio of 1:1.

1-2-2. Preparation of Urethane Polymers 2 to 8

Urethane polymers 2 to 8 were obtained in substantially the same manner as urethane polymer 1 except that the reaction times in the preparation of urethane polymers 0 and urethane polymer 14 were adjusted so that a weight-average molecular weight of an obtained polymer becomes each value shown in Table 3.

1-2-3. Preparation of Urethane Polymer 9

Urethane polymer 9 with a weight-average molecular weight of 16,000 and a functional group equivalent of 1 was obtained in substantially the same manner as urethane polymer 1 except for changing the polycarbonate diol used in the preparation of urethane polymer 0 and urethane polymer 14 to ETERNACOLL UH-300 with a weight-average molecular weight of about 3,000 (from Ube Industries, Ltd.) and adjusting the reaction times such that a molecular weight of an obtained polymer becomes 16,000.

1-2-4. Preparation of Urethane Polymer 10

Urethane polymer 10 with a weight-average molecular weight of 9,000 and a functional group equivalent of 1 was obtained in substantially the same manner as urethane polymer 1 except for changing the polycarbonate diol used in the preparation of urethane polymer 0 and urethane polymer 14 to PLACCEL CD 210 with a weight-average molecular weight of about 1,000 (from Daicel Corporation, “PLACCEL” is a registered trademark of the firm) and adjusting the reaction times such that a molecular weight of an obtained polymer becomes 9,000.

1-2-5. Preparation of Urethane Polymer 11

Urethane polymer 11 with a weight-average molecular weight of 11,000 and a functional group equivalent of 1 was obtained in substantially the same manner as urethane polymer 1 except for changing the polycarbonate diol used in the preparation of urethane polymer 0 and urethane polymer 14 to OD-X-102 with a weight-average molecular weight of about 2,000 (from DIC Corporation) and adjusting the reaction times such that a molecular weight of an obtained polymer becomes 11,000.

1-2-6. Preparation of Urethane Polymer 12

Urethane polymer 12 with a weight-average molecular weight of 12,000 and a functional group equivalent of 2 was obtained in substantially the same manner as urethane polymer 0 except for changing the polycarbonate diol used in the preparation of urethane polymer 0 to polypropylene glycol with a weight-average molecular weight of about 4,000 (Polypropylene Glycol 4000, from Wako Pure Chemical Industries, Ltd.).

1-2-7. Preparation of Urethane Polymer 15

Urethane polymer 15 with a weight-average molecular weight of 13,000 and a functional group equivalent of 0 was obtained in substantially the same manner as urethane polymer 14 except for changing the polycarbonate diol used in the preparation of urethane polymer 14 to OD-X-102 with a weight-average molecular weight of about 2,000 (from DIC Corporation) and adjusting the reaction time such that a weight-average molecular weight of an obtained polymer becomes 13,000.

1-2-8. Preparation of Urethane Polymer 16

Urethane polymer 16 with a weight-average molecular weight of 13,000 and a functional group equivalent of 0 was obtained in substantially the same manner as urethane polymer 14 except for changing the polycarbonate diol used in the preparation of urethane polymer 14 to polypropylene glycol with a weight-average molecular weight of about 4,000 (Polypropylene Glycol 4000, from Wako Pure Chemical Industries, Ltd.).

1-2-9. Other Polymers
As other polymers, the following products were used.
Urethane polymer 13: UN-7600 (from Negami Chemical Industries, Co., Ltd.)
Isoprene rubber: UC-102 (polyisoprene having a methacryloyl group in the side chain, from Kuraray Co., Ltd.)

Table 3 shows each polymer. In Table 3, the numbers in the column of “Molecular Weight” are a weight-average molecular weight of each polymer, the numbers in the column of “Functional Group Equivalent” are a functional group equivalent of each polymer, and the numbers in the column of “SP Value” are a SP value of each polymer. SP values are values estimated through Bicerano method by inputting a structure of each compound into Scigress version 2.6 installed in a commercial personal computer.

TABLE 3
Polymers

| | | Molecular | Functional | SP Value |
|---|---|---|---|---|
| | | Weight | Group | ((cal/ |
| Polymer | Abbreviation | (Mw) | Equivalent | cm³)^{1/2}) |
| Urethane Polymer 1 | UP 1 | 13000 | 1 | 9.39 |
| Urethane Polymer 2 | UP 2 | 4000 | 1 | 9.39 |
| Urethane Polymer 3 | UP 3 | 6000 | 1 | 9.39 |
| Urethane Polymer 4 | UP 4 | 7000 | 1 | 9.39 |
| Urethane Polymer 5 | UP 5 | 28000 | 1 | 9.39 |
| Urethane Polymer 6 | UP 6 | 32000 | 1 | 9.39 |
| Urethane Polymer 7 | UP 7 | 78000 | 1 | 9.39 |
| Urethane Polymer 8 | UP 8 | 82000 | 1 | 9.39 |
| Urethane Polymer 9 | UP 9 | 16000 | 1 | 9.25 |
| Urethane Polymer 10 | UP 10 | 9000 | 1 | 9.87 |
| Urethane Polymer 11 | UP 11 | 11000 | 1 | 9.36 |
| Urethane Polymer 12 | UP 12 | 12000 | 2 | 9.28 |
| Urethane Polymer 13 | UP 13 | 8500 | 2 | 9.11 |
| Urethane Polymer 14 | UP 14 | 13000 | 0 | 9.39 |
| Urethane Polymer 15 | UP 15 | 13000 | 0 | 9.36 |
| Urethane Polymer 16 | UP 16 | 13000 | 0 | 9.28 |
| Isoprene Rubber | IR | 17000 | 2 | 8.59 |

1-3. Model Material Inks

Model material inks 1 to 34 and 38 were each prepared by stirring a monomer composition shown in Table 2, a polymer shown in Table 3, and IRGACURE 819 as a photopolymerization initiator (from BASF SE, “IRGACURE” is a registered trademark of the firm, hereinafter also simply referred to as “819”) in amounts corresponding to each composition shown in Tables 4 to 6 while heating at 80° C. to dissolve.

Model material ink 35 was prepared by stirring monomer composition 1 and the photopolymerization initiator in amounts according to the composition shown in Table 6 while heating at 80° C. to dissolve.

Model material ink 36 was prepared by combining UP 1 and the photopolymerization initiator in amounts shown in Table 6.

Model material ink 37 is a commercial model material ink free from a ring-forming monomer (VeroWhite, from Objet, Inc.).

In Tables 4 to 6, the numbers in the column of “SP Value Difference” are an absolute value obtained by subtracting a SP value of a polymer from a SP value of a monomer composition.

TABLE 4
Model Material Inks No. 1 to 14

| Model | Monomer | | | | Photopolymerization | | |
|---|---|---|---|---|---|---|---|
| Material Ink | Composition | | Polymer | | Initiator | | SP Value Difference |
| No. | No. | Mass % | Type | Mass % | Type | Mass % | ((cal/cm³)^{1/2}) |
| 1 | 1 | 96 | UP 1 | 3 | IRGACURE 819 | 1 | 0.38 |
| 2 | 1 | 94 | UP1 | 5 | IRGACURE 819 | 1 | 0.38 |
| 3 | 1 | 84 | UP 1 | 15 | IRGACURE 819 | 1 | 0.38 |
| 4 | 1 | 79 | UP 1 | 20 | IRGACURE 819 | 1 | 0.38 |
| 5 | 1 | 64 | UP 1 | 35 | IRGACURE 819 | 1 | 0.38 |
| 6 | 1 | 59 | UP 1 | 40 | IRGACURE 819 | 1 | 0.38 |
| 7 | 1 | 84 | UP 14 | 15 | IRGACURE 819 | 1 | 0.38 |
| 8 | 1 | 79 | UP 15 | 20 | IRGACURE 819 | 1 | 0.41 |
| 9 | 1 | 79 | UP 16 | 20 | IRGACURE 819 | 1 | 0.49 |
| 10 | 1 | 79 | UP 11 | 20 | IRGACURE 819 | 1 | 0.41 |
| 11 | 1 | 79 | UP 12 | 20 | IRGACURE 819 | 1 | 0.49 |
| 12 | 1 | 79 | UP 13 | 20 | IRGACURE 819 | 1 | 0.66 |
| 13 | 1 | 79 | UP 9 | 20 | IRGACURE 819 | 1 | 0.52 |
| 14 | 1 | 79 | UP 10 | 20 | IRGACURE 819 | 1 | 0.10 |

TABLE 5
Table 5: Model Material Inks No. 15 to 27

| Model | Monomer | | | | Photopolymerization | | |
|---|---|---|---|---|---|---|---|
| Material Ink | Composition | | Polymer | | Initiator | | SP Value Difference |
| No. | No. | Mass % | Type | Mass % | Type | Mass % | ((cal/cm³)^{1/2}) |
| 15 | 1 | 79 | IR | 20 | IRGACURE 819 | 1 | 1.18 |
| 16 | 1 | 79 | UP 3 | 20 | IRGACURE 819 | 1 | 0.38 |
| 17 | 1 | 79 | UP 4 | 20 | IRGACURE 819 | 1 | 0.38 |
| 18 | 1 | 79 | UP 5 | 20 | IRGACURE 819 | 1 | 0.38 |
| 19 | 1 | 79 | UP 6 | 20 | IRGACURE 819 | 1 | 0.38 |
| 20 | 1 | 79 | UP 7 | 20 | IRGACURE 819 | 1 | 0.38 |
| 21 | 2 | 79 | UP 1 | 20 | IRGACURE 819 | 1 | 0.25 |
| 22 | 3 | 79 | UP 1 | 20 | IRGACURE 819 | 1 | 0.32 |
| 23 | 4 | 79 | UP 1 | 20 | IRGACURE 819 | 1 | 0.89 |
| 24 | 5 | 79 | UP 1 | 20 | IRGACURE 819 | 1 | 0.30 |
| 25 | 6 | 79 | UP 1 | 20 | IRGACURE 819 | 1 | 0.31 |
| 26 | 7 | 79 | UP 1 | 20 | IRGACURE 819 | 1 | 0.74 |
| 27 | 8 | 79 | UP 1 | 20 | IRGACURE 819 | 1 | 1.56 |

TABLE 6
Table 6: Model Material Inks No. 28 to 36 and 38

| Model | Monomer | | | | Photopolymerization | | |
|---|---|---|---|---|---|---|---|
| Material Ink | Composition | | Polymer | | Initiator | | SP Value Difference |
| No. | No. | Mass % | Type | Mass % | Type | Mass % | ((cal/cm³)^{1/2}) |
| 28 | 9 | 79 | UP 1 | 20 | IRGACURE 819 | 1 | 1.27 |
| 29 | 1 | 59 | UP 7 | 40 | IRGACURE 819 | 1 | 0.38 |
| 30 | 8 | 79 | UP 13 | 20 | IRGACURE 819 | 1 | 1.84 |
| 31 | 1 | 79 | UP 2 | 20 | IRGACURE 819 | 1 | 0.38 |
| 32 | 1 | 79 | UP 8 | 20 | IRGACURE 819 | 1 | 0.38 |
| 33 | 9 | 79 | IR | 20 | IRGACURE 819 | 1 | 2.07 |
| 34 | 6 | 79 | UP 10 | 20 | IRGACURE 819 | 1 | 0.17 |
| 35 | 1 | 99 | — | 0 | IRGACURE 819 | 1 | — |
| 36 | — | 0 | UP 1 | 99 | IRGACURE 819 | 1 | — |
| 38 | 10 | 79 | UP 1 | 21 | IRGACURE 819 | 1 | 0.91 |

2. Support Material Ink

A support material ink was prepared by mixing and dissolving the following components in the following amounts.

Octadecanol 60 weight parts

Hexadecanol 40 weight parts

3. Fabrication of Three-Dimensional Objects

3-1. Fabrication of First Three-Dimensional Objects

In a three-dimensional fabrication system equipped with two inkjet heads and ink tanks connected with the respective inkjet heads, a first ink tank connected with a first inkjet head (Piezo Head 512L, from Konica Minolta IJ Technologies, Inc.) and a second ink tank connected with a second inkjet head (Piezo Head 512L, from Konica Minolta IJ Technologies, Inc.) were filled with model material ink 1 and the support material ink, respectively. A first layer containing model material layer 100 and support material layer 200 was formed by ejecting model material ink 1 from the first inkjet head and the support material ink from the second inkjet head to allow to impact while scanning the stage in the horizontal direction, and curing/hardening through UV irradiation from a light source.

Then, a second layer was stacked by elevating the first inkjet head, the second inkjet head, and the light source in the vertical direction, impacting model material ink 1 and the support material ink on the formed first layer, and curing/hardening in substantially the same manner as above. Three-dimensional object 1 containing support material 210-attached model material 110 of a predetermined shape was fabricated by repeating the similar steps until a predetermined thickness and shape are obtained while changing ejection positions of model material ink 1 and the support material ink as needed. As illustrated in FIG. 1D, a first three-dimensional object has a shape of two rectangular parallelepipeds (in size of width 30 mm×height 30 mm×thickness 2 mm) connected through a bridge section (length 30 mm×height 5 mm×thickness 2 mm) at portions in the same distances from the top and bottom ends in the height direction of each rectangular parallelepiped.

A head temperature during ejection of an ink was set to “a temperature of 75° C. or lower at which the viscosity of the ink becomes 10 mPa·s” or to “75° C.” when the viscosity of the ink exceeds 10 mPa·s even at 75° C. During ejection of an ink, a volume of one droplet was set to 42 pL, and a frequency was set to 8 kHz. A 395 nm LED was used as a UV light source, and the conditions were set so that each layer is irradiated with light at an irradiance of 100 mW/cm² for 1 second. A scanning rate of the head was set to 300 mm/sec.

First three-dimensional object 1 was obtained by placing support material-attached three-dimensional object 1 in an oven at 60° C. for 5 minutes and removing support material 210.

First three-dimensional objects 2 to 31, 33 to 35, 37, and 38 were obtained in substantially the same manner as above except for changing model material ink 1 to model material inks 2 to 31, 33 to 35, 37, and 38, respectively. First three-dimensional objects were not fabricated using high-viscosity model material inks 32 and 36 in order to prevent damage on the first inkjet head.

3-2. Fabrication of Second Three-Dimensional Objects

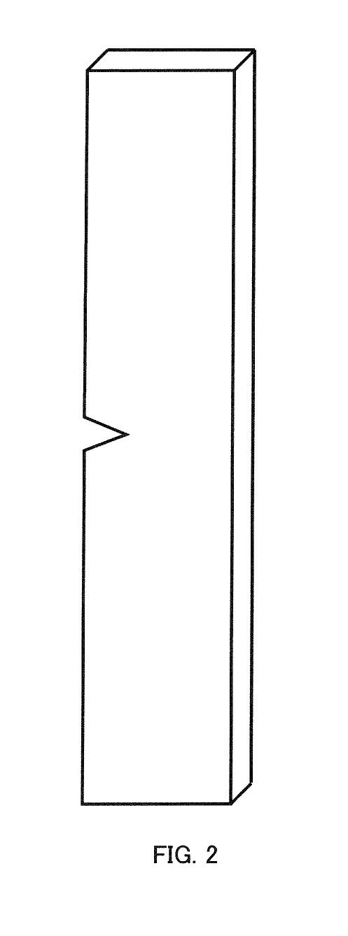

Second three-dimensional objects 1 to 31, 33 to 35, 37, and 38 were fabricated substantially the same manner as first three-dimensional objects 1 to 31, 33 to 35, 37, and 38, respectively. Second three-dimensional objects were not fabricated using high-viscosity model material inks 32 and 36 in order to prevent damage on the first inkjet head. As illustrated in FIG. 2, a second three-dimensional object has a linear tapered notch (opening width 3 mm×depth 2 mm) at a portion in the same distances from the top and bottom ends in the height direction of the rectangular parallelepiped (in size of width 10 mm×height 110 mm×thickness 2 mm).

4. Evaluation

4-1. Ejection Properties

An ink viscosity at 70° C. for each model material ink 1 to 38 was measured using a MCR 02 rheometer (from Anton Paar GmbH) in temperature rising of an ink from 20° C. to 100° C. at a rising rate of 3° C./min. When the ink viscosity is 20 mPa·s or lower, it is determined that high-speed discharge of an ink in a sufficient volume from an inkjet head is possible during fabrication of a three-dimensional object.

Good: ink viscosity of 20 mPa·s or lower

Poor: ink viscosity of higher than 20 mPa·s

4-2. Tensile Strength

Stress at break for each first three-dimensional object 1 to 31, 33 to 35, 37, and 38 was measured by performing a tensile test using a TENSILON RTF-2430 universal material testing instrument (from A&D Company, Limited) at a pulling speed of 30 mm/min and an inter-chuck distance of 5 cm.

A: stress at break of 45 MPa or more

B: stress at break of 37 MPa or more and less than 45 MPa

C: stress at break of 29 MPa or more and less than 37 MPa

D: stress at break of 21 MPa or more and less than 29 MPa

E: stress at break of less than 21 MPa

4-3. Impact Resistance

Breaking energy (kJ/m) was measured for each second three-dimensional object 1 to 31, 33 to 35, 37, and 38 using an Izod impact tester (from YASUDA SEIKI SEISAKUSHO, LTD.) according to JIS K 7110 (hammer 5.5 J, in an Izod test mode).

A: breakage at 15 kJ/m² or more

B: breakage at 10 kJ/m² or more and less than 15 kJ/m²

C: breakage at 4 kJ/m² or more and less than 10 kJ/m²

D: breakage at less than 4 kJ/m²

4-4. Results

Results are shown in Tables 7 to 9.

TABLE 7
Evaluation of Three-dimensional Objects No. 1 to 14

| | | SP Value | | | |
|---|---|---|---|---|---|
| Three-dimensional | | Difference | Ejection | Tensile | Impact |
| Object No. | Ink | ((cal/cm³)^{1/2}) | Properties | Strength | Resistance |
| 1 | 1 | 0.38 | Good | C | B |
| 2 | 2 | 0.38 | Good | A | A |
| 3 | 3 | 0.38 | Good | A | A |
| 4 | 4 | 0.38 | Good | A | A |
| 5 | 5 | 0.38 | Good | A | A |
| 6 | 6 | 0.38 | Good | C | A |
| 7 | 7 | 0.38 | Good | A | B |
| 8 | 8 | 0.41 | Good | A | B |
| 9 | 9 | 0.49 | Good | A | B |
| 10 | 10 | 0.41 | Good | A | A |
| 11 | 11 | 0.49 | Good | A | A |
| 12 | 12 | 0.66 | Good | A | A |
| 13 | 13 | 0.52 | Good | A | A |
| 14 | 14 | 0.10 | Good | D | D |

TABLE 8
Evaluation of Three-dimensional Objects No. 15 to 27

| | | SP Value | | | |
|---|---|---|---|---|---|
| Three-dimensional | | Difference | Ejection | Tensile | Impact |
| Object No. | Ink | ((cal/cm³)^{1/2}) | Properties | Strength | Resistance |
| 15 | 15 | 1.18 | Good | C | B |
| 16 | 16 | 0.38 | Good | B | A |
| 17 | 17 | 0.38 | Good | A | A |
| 18 | 18 | 0.38 | Good | A | A |
| 19 | 19 | 0.38 | Good | B | A |
| 20 | 20 | 0.38 | Good | B | A |
| 21 | 21 | 0.25 | Good | A | A |
| 22 | 22 | 0.32 | Good | A | A |
| 23 | 23 | 0.89 | Good | A | A |
| 24 | 24 | 0.30 | Good | A | A |
| 25 | 25 | 0.31 | Good | A | A |
| 26 | 26 | 0.74 | Good | A | A |
| 27 | 27 | 1.56 | Good | A | A |

TABLE 9
Evaluation of Three-dimensional Objects No. 28 to 38

| | | SP Value | | | |
|---|---|---|---|---|---|
| Three- | | Difference | | | |
| dimensional | | ((cal/ | Ejection | Tensile | Impact |
| Object No. | Ink | cm³)^{1/2}) | Properties | Strength | Resistance |
| 28 | 28 | 1.27 | Good | A | A |
| 29 | 29 | 0.38 | Good | C | A |
| 30 | 30 | 1.84 | Good | A | A |
| 31 | 31 | 0.38 | Good | E | D |
| 32 | 32 | 0.38 | Poor | — | — |
| 33 | 33 | 2.07 | Good | E | D |
| 34 | 34 | 0.17 | Good | D | D |
| 35 | 35 | — | Good | E | D |
| 36 | 36 | — | Poor | — | — |
| 37 | VeroWhite | 1.27 | Good | B | D |
| 38 | 38 | 0.91 | Excellent | D | D |

Model material inks No. 1 to 13 and 15 to 30 each had an ink viscosity such that an ink in a sufficient amount can be discharged at a high speed from an inkjet head, and three-dimensional objects No. 1 to 13 and 15 to 30 fabricated using these model material inks exhibited high tensile strength and impact resistance.

Three-dimensional objects No. 2 to 5, 7 to 28, and 30 fabricated using model material inks No. 2 to 5, 7 to 13, 15 to 28, and 30 with a content of a polymer of 5 mass % or more and 35 mass % or less exhibited higher tensile strength (compared with three-dimensional objects No. 1, 6, and 29).

Three-dimensional objects fabricated using model material inks No. 1 to 6, 10 to 13, and 15 to 30, in which a polymer has 1 molar equivalent or more of a photopolymerizable functional group, tended to exhibit higher impact resistance (compared with three-dimensional objects No. 7 to 9).

Three-dimensional objects No. 1 to 14 and 16 to 30 fabricated using model material inks No. 1 to 13 and 16 to 30 containing a urethane polymer as a polymer tended to achieve both high tensile strength and high impact resistance (compared with three-dimensional objects No. 15).

Three-dimensional objects fabricated using model material inks No. 1 to 13, 15, 17, 18, and 21 to 30 with a molecular weight of a polymer of 7,000 or more and 30,000 or less tended to achieve both high tensile strength and high impact resistance (compared with three-dimensional objects No. 16, 19, and 20).

In contrast, three-dimensional object No. 37 fabricated using model material ink No. 37 free from a ring-forming monomer exhibited low impact resistance. Similarly, three-dimensional object No. 38 fabricated using model material ink No. 38 free from a ring-forming monomer exhibited low tensile strength and impact resistance.

Three-dimensional objects No. 14 and 34 fabricated using model material inks No. 14 and 34 with a difference between a SP value of the photopolymerizable monomer and a SP value of the polymer of less than 0.30 (cal/cm³)^{1/2}, as well as three-dimensional object No. 33 fabricated using model material ink No. 33 with a difference between a SP value of the photopolymerizable monomer and a SP value of the polymer is more than 2.0 (cal/cm³)^{1/2} exhibited low tensile strength and impact resistance.

Three-dimensional object No. 31 fabricated using model material ink No. 31 with a molecular weight of the polymer of less than 5,000 exhibited low tensile strength and impact resistance. Further, three-dimensional object No. 32 fabricated using model material ink No. 32 with a molecular weight of the polymer of more than 80,000 was not suitable for fabrication of a three-dimensional object through discharge from an inkjet head due to its high viscosity.

Three-dimensional object No. 35 fabricated using model material ink No. 35 free from a polymer exhibited low tensile strength and impact resistance.

Three-dimensional object No. 36 fabricated using model material ink No. 36 free from a monomer composition was not suitable for fabrication of a three-dimensional object through discharge from an inkjet head due to its high viscosity.

### INDUSTRIAL APPLICABILITY

The model material ink of the present invention has low viscosity and enables fabrication of a three-dimensional object with high tensile strength and impact resistance. Accordingly, the model material ink can be preferably used for inkjet fabrication of prototypes for products which bear load in operation, such as screwing parts and snap parts.

This application is entitled to and claims the benefit of Japanese Patent Application No. 2015-047363, filed on Mar. 10, 2015, the disclosure of which including the specification and drawings is incorporated herein by reference in its entirety.

### REFERENCE SIGNS LIST

100 Model material layer
110 Model material
200 Support material layer
210 Support material

1. An ink composition for three-dimensional fabrication by an inkjet method, the ink composition comprising:
at least one photopolymerizable monomer including a monomer which is to form a ring structure in a main chain by polymerization;
at least one polymer with a weight-average molecular weight of 5,000 or more and 80,000 or less; and
a photopolymerization initiator,
wherein a difference between a solubility parameter of the at least one photopolymerizable monomer and a solubility parameter of the at least one polymer is 0.30 (cal/cm³)^{1/2} or more and 2.0 (cal/cm³)^{1/2} or less.

2. The ink composition according to claim 1, wherein the photopolymerizable monomer which is to form a ring structure in a main chain by polymerization is a compound represented by formula 1: 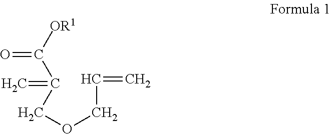
wherein R¹ is a hydrogen atom or a C_{≦20} hydrocarbon group which is substituted or unsubstituted.

3. The ink composition according to claim 1, wherein a content of the at least one polymer is 5 mass % or more and 35 mass % or less.

4. The ink composition according to claim 1, wherein the at least one polymer has 1 molar equivalent or more of a photopolymerizable functional group, relative to 1 mole of the at least one polymer.

5. The ink composition according to claim 1, wherein a weight-average molecular weight of the at least one polymer is 7,000 or more and 30,000 or less.

6. The ink composition according to claim 1, wherein the at least one polymer has a structural segment which is compatible with the at least one photopolymerizable monomer and a structural segment which is incompatible with the at least one photopolymerizable monomer.

7. The ink composition according to claim 1, wherein the at least one polymer includes a urethane polymer.

8. An ink set for three-dimensional fabrication by an inkjet method, the ink set comprising:
the ink composition for three-dimensional fabrication according to claim 1; and
an ink composition for forming a support region.

9. A method of fabricating a three-dimensional object, the method comprising:
forming a first ink layer region by discharging the ink composition for three-dimensional fabrication according to claim 1 from a nozzle of a first inkjet head;
forming a model material layer region by irradiating the first ink layer region formed with actinic radiation; and
repeating the forming of the first ink layer region and the forming of the model material layer region, thereby stacking a plurality of the model material layer regions to fabricate a three-dimensional object.

10. The method according to claim 9, further comprising:
forming a second ink layer region by discharging a second ink composition from a nozzle of a second inkjet head;
forming a support material layer region by solidifying the second ink layer region formed; and
repeating the forming of the second ink layer region and the forming of the support material layer region, thereby stacking a plurality of the support material layer regions.
